(19) United States
(12) Patent Application Publication
(10) Pub. No.: US 2003/0228092 A1
(43) Pub. Date: Dec. 11, 2003

(54) Wavelength-selective optical switch

(76) Inventors: Sean Chang, Tao Yuan City (TW); Shih-Chien Chang, Tai Shan Hsiang (TW)

Correspondence Address: PRO-TECHTOR INTERNATIONAL, 20775 Norada Court, Saratoga, CA, 95070-3018, US

(21) Appl. No.: 10/214,080

(22) Filed: Aug. 6, 2002

(30) Foreign Application Priority Data
Jun. 7, 2002 (TW) 91112477

(51) Int. Cl. G02B 6/28

(52) U.S. Cl. 385/24

(57) ABSTRACT

A wavelength-selective optical switch includes a beam-splitting device and a plurality of wavelength tunable filters. The beam-splitting device distributes input optical signals to the plurality of wavelength tunable filters so that the optical signals entering each of the plurality of wavelength tunable filters have all wavelengths of the input optical signals.

### BACKGROUND OF THE INVENTION

1. Field of the Invention

The present invention relates to a wavelength optical switch, and more particularly, to a wavelength-selective optical switch with each of its output terminals capable of switching between different output wavelengths.

2. Description of the Related Art

In earlier days, the optical fiber transmission utilizes a particular wavelength to carry a certain kind of information. However, an optical fiber allows only one wavelength to pass through at a time, and therefore the bandwidth provided becomes insufficient. Later on, it was considered that light beams having different wavelengths do not interfere with one another, so that concepts of wavelength-combination and wavelength-division occurred to have several light sources with different wavelength representing a plurality of information pass through an optical fiber, thereby multiplying the bandwidth of an optical fiber. FIG. 1 is a schematic diagram showing a wavelength-division multiplexer (WDM) according to the prior art.

Referring to FIG. 1, the WDM 101 includes an optical multiplexer 102 coupled from individual light sources with different wavelength to a transmission optical fiber 104, and an optical demultiplexer 103 capable of separating those different wavelengths. With the combination described above, the single transmission optical fiber 104 is able to expand its available bandwidth by transmitting light waves having different wavelengths. However, when employing the conventional wavelength-division multiplexer 101, each output terminal is only able to output a light beam having one particular wavelength but not a wavelength selected arbitrarily from all the input wavelengths. Therefore, by providing that each light output terminal can switch among the wavelengths, the flexibility of optical path designs and applications can be significantly increased.

### SUMMARY OF THE INVENTION

Therefore, it is an object of the invention to provide a wavelength-selective optical switch, which uses a combination of a beam-splitting device and a plurality of wavelength tunable filters, so that each output terminal of the wavelength-selective optical switch is able to arbitrarily switch among the wavelengths. The beam-splitting device distributes input optical signals to each of the plurality of wavelength tunable filters.

According to an embodiment of the invention, when input optical signals are in the form of a light beam having N-unit of wavelengths (λ₁ to λ_{N}), the beam-splitting device can be a star coupler having at least M-unit of output ports or a 1-to-M splitter.

According to another embodiment of the invention, when light beams having different mono-wavelengths enter a wavelength-selective optical switch having N-unit of input terminals and M-unit of output terminals, the beam-splitting device can be a combination made up by N-unit of 1-to-M splitters and M-unit of 1-to-N splitters, or a star coupler having at least N-unit of input ports and at least M-unit of output ports.

According to still another embodiment of the invention, the optical signals entering the wavelength-selective optical switch is a combination of light beams having a plurality of wavelengths and light beams having different mono-wavelengths.

Furthermore, the output terminals of the wavelength-selective optical switch and the plurality of wavelength tunable filters are correspondingly provided and therefore equal in quantity.

Also, the plurality of wavelength tunable filters can be micro-electro-mechanical-system Fabry-Perot (MEMS F-P) filters, fiber Bragg grating (FBG) filters, array waveguide (AWG) filters or the like.

With the combination of the beam-splitting device and tunable filters of the invention, regardless of whether the input optical signals are light beams having different mono-wavelengths, light beams consisted of multiple wavelengths, or a combination of both, the beam-splitting device is able to have the optical signals entering the plurality of wavelength tunable filters to include all wavelengths of the input optical signals. Then, by using the tunable filters to arbitrarily select a wavelength from all wavelengths as the output wavelength, each output terminal of the wavelength-selective optical switch can achieve the effect of switching among different output wavelengths, thereby significantly increasing the flexibility of light path designs and applications.

### BRIEF DESCRIPTION OF THE DRAWINGS

FIG. 1 is a schematic diagram of a wavelength division multiplexer according to the prior art.

FIG. 2 is a schematic diagram of a wavelength-selective optical switch according to the first preferred embodiment of the present invention.

FIG. 3 is a schematic diagram of a wavelength-selective optical switch according to the second preferred embodiment of the present invention.

FIG. 4 is a schematic diagram of a wavelength-selective optical switch which utilizes a star coupler to function as a beam-splitting device according to the third preferred embodiment of the present invention.

### DESCRIPTION OF THE PREFERRED EMBODIMENTS

A wavelength-selective optical switch in accordance with an embodiment of the present invention will be described with reference to the accompanying drawings, wherein the same reference numerals denote the same elements.

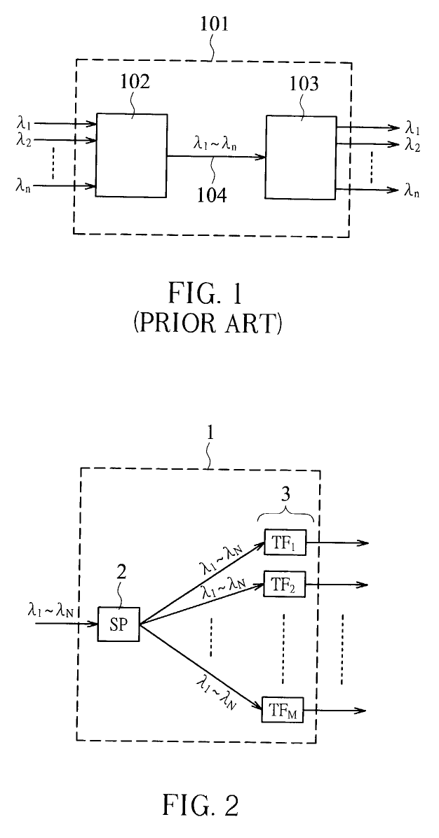

The wavelength-selective optical switch of the present invention includes a beam-splitting device and a plurality of wavelength tunable filters. FIG. 2 is a schematic diagram of the wavelength-selective optical switch 1 according to the first preferred embodiment of the present invention. The beam-splitting device of the first embodiment is a 1-to-M splitter (SP) 2. “1-to-M” means that when a light beam enters the splitter, the light beam is distributed to M-unit of outputs, and vice versa, the splitter has the effect of combining M-unit of light beams into one light beam. Similar abbreviations to be mentioned in the following description stand for the same meaning.

Referring to FIG. 2, when a light beam having wavelengths of λ₁ to λ_{N} enters the wavelength-selective optical switch 1, the light beam first enters the 1-to-M splitter 2. Then, the 1-to-M splitter divides the light beam having N-unit of wavelengths into M-unit of light beams, and thus each of the divided light beams has wavelengths of λ₁ to λ_{N}. Besides, M-unit of wavelength tunable filters (TF₁ to TF_{M}) 3 are provided corresponding to the light paths of the M-unit of light beams having wavelengths of λ₁ to λ_{N}.

Therefore, according to the first preferred embodiment of the present invention, by using a combination made up by the 1-to-M splitter 2 and the M-unit of wavelength tunable filters 3, the wavelength-selective optical switch 1 of the invention is able to arbitrarily select any wavelength from λ₁, λ₂, λ₃ . . . λ_{N-1}, λ_{N} as an output wavelength. Thereby, each of the output ports can arbitrarily switch among output wavelengths.

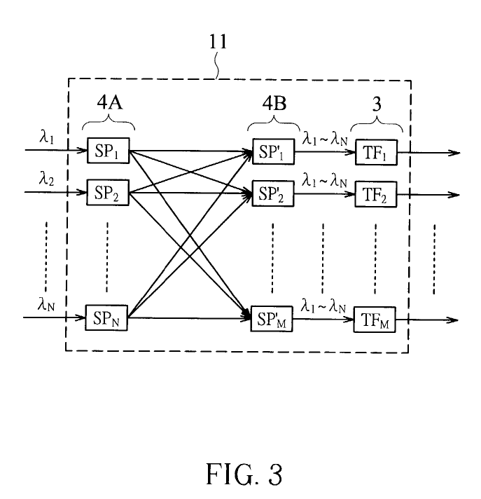

FIG. 3 is a schematic diagram of a wavelength-selective optical switch 11 when an incident light beam has N-unit of different mono-wavelengths (λ₁, λ₂, λ₃ . . . λ_{N-1}, λ_{N}) according to the second preferred embodiment of the present invention. It is the same as the first preferred embodiment, the wavelength-selective optical switch 11 has M-unit of output ports provided corresponding to the number of the wavelength tunable filters 3.

As shown in FIG. 3, N-unit of 1-to-M splitters (SP₁ to SP_{N}) 4A are provided corresponding to the N-unit of light beams having different mono-wavelengths, and then M-unit of 1-to-N splitters (SP′₁ to SP′_{M}) 4B are provided corresponding to the number of wavelength tunable filters 3 (TF₁ to TF_{M}). When each light beam having a mono-wavelength (for example, λ₁) enters a corresponding 1-to-M splitter (for example, SP₁), the light beam having a wavelength of λ₁ is divided into M-unit of optical signals having the same wavelength. Then, the M-unit of optical signals having the same wavelength enter each 1-to-N splitter of the M-unit of splitters 4B, respectively. Subsequently, each splitter (for example, SP′₁) of the 1-to-N splitters 4B combines the N-unit of divided light beams from the splitters 4A into a light beam having different wavelengths of λ₁ to λ_{N}, which then enters the tunable filters 3 (TF₁ to TF_{M}). As a result, the wavelength tunable filters 3 can arbitrarily select any wavelength from λ₁, λ₂, λ₃ . . . X_{N-1}, λ_{N} as an output wavelength. Thereby, each output terminal is capable of arbitrarily switching a desired output from the N-unit of wavelengths.

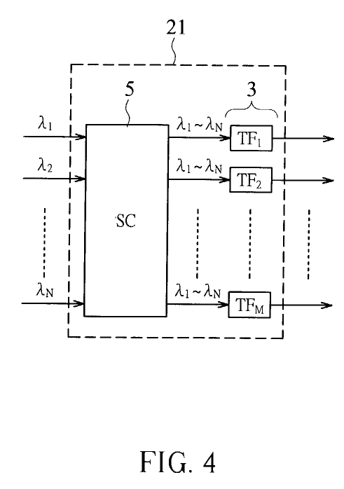

FIG. 4 is a schematic diagram of a wavelength-selective optical switch 21 which utilizes a star coupler (SC) 5 to function as a beam-splitting device according to the third preferred embodiment of the present invention. The star coupler 5 is able to distribute required power from any input port to each output port. Referring to FIG. 4, in the embodiment, M-unit of output terminals are provided corresponding to the number of the wavelength tunable filters 3. When N-unit of light beams having different mono-wavelengths enter the wavelength-selective optical switch 21, the star coupler (SC) 5, with respect to the number of M-unit output ports, divides each of the incident light beams into M-unit of lights to be subsequently incident on each of the wavelength tunable filters 3. In other words, each of the M-unit of wavelength tunable filters 3 can receive N-unit of light beams with different wavelengths. Each of the filters 3 then selects any wavelength from λ₁, λ₂, λ₃ . . . λ_{N-1}, λ_{N} as an output wavelength, thereby achieving the effect that each output terminal can arbitrarily switch among any of the N-unit of wavelengths. Furthermore, if the light beams incident on each of the input terminals include multiple wavelengths, the star coupler 5 is still able to distribute the light beams to each of the output ports and achieve the same effect.

To sum up, the invention uses a combination of beam-splitting devices and tunable filters with different configurations. Therefore, regardless of the optical signals entering the wavelength-selective optical switch being light beams having different mono-wavelengths, light beams having multiple wavelengths, or a combination of both, the beam-splitting device is able to have the optical signals entering the plurality of wavelength tunable filters to include all wavelengths of the input optical signals. Then, the wavelength tunable filters arbitrarily select any wavelength from all the wavelengths as an output wavelength. Thereby, each optical output terminal can arbitrarily switch different output wavelengths, which significantly increases the flexibility of light path designs and applications.

In addition, the tunable filters of the invention can be micro-electro-mechanical-system Fabry-Perot (MEMS F-P) filters, fiber Bragg grating (FBG) filters, array waveguide (AWG) filters or the like.

Due to the development trend of integrating all devices by planar lightwave circuit (PLC) and micro-electro-mechanical-system techniques, the volume, control and light path designs of the wavelength-selective optical switch of the invention is further favored to a more advantageous position.

While the invention has been particularly described, in conjunction with specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the invention.

What is claimed is:

1. A wavelength-selective optical switch for switching output wavelengths of input optical signals, comprising:
a plurality of wavelength tunable filters; and
a beam-splitting device for distributing the input optical signals to each of the plurality of wavelength tunable filters.

2. The wavelength-selective optical switch as claimed in claim 1, wherein the beam-splitting device includes at least one splitter.

3. The wavelength-selective optical switch as claimed in claim 1, wherein the beam-splitting device is a star coupler.

4. The wavelength-selective optical switch as claimed in claim 1, wherein the plurality of wavelength tunable filters are micro-electro-mechanical-system Fabry-Perot (MEMS F-P) filters.

5. The wavelength-selective optical switch as claimed in claim 1, wherein the plurality of wavelength tunable filters are fiber Bragg grating (FBG) filters.

6. The wavelength-selective optical switch as claimed in claim 1, wherein the plurality of wavelength tunable filters are array waveguide (AWG) filters.

7. The wavelength-selective optical switch as claimed in claim 1, wherein the input optical signals are a light beam having a plurality of wavelengths.

8. The wavelength-selective optical switch as claimed in claim 1, wherein the input optical signals are light beams having mono-wavelengths.

9. The wavelength-selective optical switch as claimed in claim 1, wherein the input optical signals are composed of light beams having a plurality of wavelengths and light beams having mono-wavelengths.

10. The wavelength-selective optical switch as claimed in claim 1, wherein the beam-splitting device enables the optical signals entering each of the plurality of wavelength tunable filters to have all wavelengths of the input optical signals.

11. The wavelength-selective optical switch as claimed in claim 1, further comprising:
at least one input terminal; and
a plurality of output terminals provided corresponding to the plurality of wavelength tunable filters.

12. The wavelength-selective optical switch as claimed in claim 11, wherein optical signals entering the at least one input terminal are light beams with N-unit of wavelengths (λ₁ to λ_{N}).

13. The wavelength-selective optical switch as claimed in claim 11, wherein optical signals entering the at least one input terminal are light beams having mono-wavelengths.

14. The wavelength-selective optical switch as claimed in claim 11, wherein optical signals entering the at least one input terminal are composed of light beams having a plurality of wavelengths and light beams having mono-wavelengths.

15. The wavelength-selective optical switch as claimed in claim 11, wherein the beam-splitting device is a star coupler.

16. The wavelength-selective optical switch as claimed in claim 13, wherein when the number of the input terminals entered by the light beams having mono-wavelengths is N and the number of the output terminals is M, the beam-splitting device is composed of N-unit of 1-to-M splitters and M-unit of 1-to-N splitters.

17. The wavelength-selective optical switch as claimed in claim 13, wherein when the number of the input terminals entered by the light beams having mono-wavelength is N and the number of the output terminals is M, the beam-splitting device is a star coupler having at least N-unit of input ports and M-unit of output ports.
